(19) United States
(12) Patent Application Publication
(10) Pub. No.: US 2015/0355829 A1
(43) Pub. Date: Dec. 10, 2015

(54) ENABLING A USER TO CONTROL CODED LIGHT SOURCES

(71) Applicant: KONINKLIJKE PHILIPS N.V., Eindhoven (NL)

(72) Inventors: LORENZO FERI, EINDHOVEN (NL); TOMMASO GRITTI, BREDA (NL); STEPHANUS JOSEPH JOHANNES NIJSSEN, EINDHOVEN (NL); FREDERIK JAN DE BRUIJN, EINDHOVEN (NL); RUBEN RAJAGOPALAN, NEUSS (DE)

(73) Assignee: Koninklijke Philips N.V., Einhoven (NL)

(21) Appl. No.: 14/760,384

(22) PCT Filed: Jan. 11, 2013
(86) PCT No.: PCT/IB2013/061407

§ 371 Date: Jul. 10, 2015

Related U.S. Application Data
(60) Provisional application No. 61/751,292, filed on Jan. 11, 2013.

(51) Int. Cl. G06F 3/0484; G06F 3/0482; G06F 3/0481

(52) U.S. Cl. CPC G06F 3/04847; G06F 3/04817; G06F 3/0482; G06F 3/04842

(57) ABSTRACT

The invention relates to a method for enabling a user to control coded light (CL) sources. The method is performed after obtaining one or more images of a scene being illuminated by at least one CL source, the image of the CL source being present within the acquired image(s). The method includes processing the acquired image(s) to determine, based on the code embedded into the light output of the CL source, that the light output of that source is present within the scene, processing the acquired image(s) to determine the location of the image of the CL source within the acquired image(s), providing a user interface illustrating the scene, and providing a control icon within the user interface, the icon indicating to a user, based on the determined location of the CL source, that the icon is adapted to control the CL source.

### FIELD OF THE INVENTION

Embodiments of the present invention relate generally to the field of illumination systems and optical receivers, and, more specifically, to systems and methods for enabling a user to individually control coded light sources included within such illumination systems.

### DESCRIPTION OF THE RELATED ART

In current lighting systems including multiple light sources, selection and control of the light sources usually occurs by fixed devices, such as wall panels having switches. The switches are used to control the light sources such as to turn lights on or off, or dim the lights. In the event a user desires to change any of the lights, the user must return to the wall panel. Of course, the user needs to know which switch controls which light source. However, often times the user does not have such information as switches or light sources are not marked. Such a situation is particularly problematic in the case of multiple light sources and multiple switches, where the switch that controls the desired light source is found by trial and error.

Recent developments have created light sources that can embed data into their light output by modulating one or more characteristics of the light output in response to a data signal. Such light output is sometimes referred to as “coded light” and abbreviated as “CL” and such light sources are then referred to as “CL sources.” Preferably, the light output is modulated at a high frequency so that the modulation is invisible to a human eye.

One scenario where CL can be applied includes light sources embedding their identifications (IDs) in their light output. This scenario is particularly useful for so-called Point&Control applications where a user can utilize the detected CL to select a light source based on the source's ID and subsequently adjust the settings of the selected light source. In principle, this provides a promise of individually controlling multiple light sources in a manner that is easier for a user than using multiple fixed switches.

Detection systems are known where a camera within a detection system is configured to acquire one or more images of a scene and the images are subsequently processed to determine whether a light output of a particular CL source is present within the scene. The camera may be implemented in a remote control for controlling the light source or included in another unit such as a switch or a sensor device. This technology also opens up the possibility to use commonly available smartphones and tablets as CL detectors, provided that those devices are equipped with cameras, as is normally the case.

While such systems allow determination of whether a light output of a particular CL source is present within a scene, if the acquired images contain images of the actual multiple light sources providing the light output, it is not always possible to identify to a user which light source provided which one of the detected light outputs.

One reason for not always being able to identify which light source produced which one of the detected CL outputs, is that pointing the camera directly to the light source tends to saturate the camera sensor. When this happens, it is impossible to do any CL detection, because saturated camera sensors are unable to detect the differences in the received signal necessary for determining the data modulation used to embed CL data.

What is needed in the art is a technique for enabling a user to individually control CL sources in a manner that improves on at least some of the problems described above.

### SUMMARY OF THE INVENTION

One object of the invention is to provide a camera-based control system and method that enable a user to identify individual CL sources illuminating a scene and provide the user with means for individually controlling such light sources. A further object of the invention is to provide a camera-based control system and a method suitable for detecting CL originating from light sources at least some of which may saturate the camera sensor in a manner that allows identifying the light sources that generated the detected CL.

A method and a corresponding control system are proposed. The method may be performed after obtaining one or more images of a scene being illuminated by an illumination system that comprises at least a first light source. The first light source is present within the scene and, therefore, the image of the first light source is present within the one or more images of that scene. The first light source is a CL source, configured for providing a first light output comprising a first code, where the first code is embedded into the first light output as a first sequence of modulations in one or more characteristics thereof, such as e.g. pulse width modulations or amplitude modulations. The method includes the steps of processing the one or more images to determine, based on the first code embedded into the first light output, that the first light output is present within the scene, and processing the one or more images to determine the location of the image of the first light source within the one or more images. The method further includes the steps of providing a user interface illustrating the scene and providing a first control icon within the user interface, the first control icon indicating to a user, based on the determined location of the first light source, that the first control icon may be used to control the first light source.

Embodiments of the present invention are based on the realization that, when one or more images of a scene are acquired, the scene including the actual light sources producing light, then, in addition to processing the acquired images to detect the presence of light output of one or more particular CL sources within the scene, the images could also be processed to determine locations, within the acquired images, of the images of the light sources responsible for the presence of the detected CL. Correctly identifying the location of a particular CL source within the images allows, in turn, placing a control icon at a correct place within a user interface illustrating the scene in a sense that the location of the control icon within the user interface corresponds to the determined location of that particular light source thereby indicating to a user that the control icon can be used to control that particular light source. The user interface illustrating the scene could be e.g. an interface displaying one of the acquired images or a schematic representation thereof. Because the scene included the first light source, an image of the scene includes an image of that light source. Since the location of the image of the first light source within the images has been determined, the first control icon may placed within the user interface so that the user can realize that this control icon is to control that particular light source. For example, the control icon may be displayed on top of the image of the first light source within the user interface. Such embodiments may be used e.g. in Point&Control applications where a user points his detection/control device to a scene including multiple light sources, obtains one or more images of the scene using the device, and then is presented with a user interface illustrating the scene and comprising control icons for the individual CL sources illuminating the scene.

In a further embodiment, each of the one or more acquired images comprises a matrix of pixels, where, as used herein, the term “pixel” in context of “a pixel of an image” refers to a unit of image data of the image corresponding to a particular point within a scene. Image data comprises intensities, or derivatives thereof, of the total light output of the illumination system at different points within the scene. Arranging image data in rows and columns of pixels is one way of representing the three-dimensional scene in a two-dimensional image. In such an embodiment, the method may further include the step of identifying at least one detection area of the one or more images, the detection area comprising a plurality of pixels allowing identification of the first code. The above-described step of processing the one or more images to determine that the first light output is present within the scene may then comprise processing the plurality of pixels of the detection area to identify the first code, where, as used in this context, the term “identify” covers not only the determination that the first code known to the control system ahead of time is present within at least a portion of the detection area but also the determination of the first code that is not known to the control system ahead of time but is present within at least a portion of the detection area. In addition, in such an embodiment, the method further include the step of identifying at least one saturation area of the one or more images, the saturation area comprising, for each of the one or more images, one or more pixels comprising an intensity above a predetermined threshold. As skilled persons will realize, a pixel comprising intensity above the predetermined threshold indicates saturation of a sensor providing the pixel data. The method may further include the steps of determining one or more characteristics of the detection area and determining one or more characteristics of the saturation area. The above-described step of processing the one or more images to determine the location of the first light source within the one or more images may then comprise identifying at least a portion of the saturation area as the location of the light source of the illumination system that provided the first light output comprising the identified first code when a match according to one or more predefined matching criteria is established between the determined characteristics of the detection area and the determined characteristics of the saturation area.

Differentiating between saturation areas, where detection of CL is not possible, and detection areas, where detection of CL is possible, allows detecting CL even though the camera acquiring the one or more images may be pointed in the direction of the light source saturating part of the image sensor of the camera. Determining and comparing the characteristic(s) of the identified saturation area with the characteristic(s) of the identified detection area allows identifying at least a portion of the saturation area as the location of the light source that generated the detected CL if the comparison determines a match in some predefined respect. Thus, embedded first code identified from one area of the acquired images, namely the detection area, may be associated with the first light source, the image of which forms at least a portion of another area of the acquired images, namely the saturation area, as the light source that generated the first code identified from the detection area. In this manner, it becomes possible to determine the location, within the acquired images, of the image of a light source that generated the light output comprising the detected embedded code even though the light source itself may saturate image sensors of the camera making it impossible to do detection of the embedded code from the pixels corresponding to the location of that light source within the scene.

When more than one detection areas and/or more than one saturation areas are identified within the acquired images, determination of the characteristic(s) may be performed for each of the identified saturation and detection areas and determination of a match between the identified characteristics may be performed for each pair of a detection area and a saturation area.

In an embodiment, the one or more characteristics of the detection area could comprise the centroid of the detection area, the one or more characteristics of the saturation area could comprise the centroid of the saturation area, and the one or more predefined matching criteria could then comprise establishing the match when a distance between the centroid of the detection area and the centroid of the saturation area is less than a predefined threshold distance. This embodiment is particularly advantageous because it does not require large processing resources and because it works well for common cases where the saturation and detection area are located close to each other in the image.

In an embodiment, the one or more characteristics of the detection area could comprise the location of the detection area within the one or more images, the one or more characteristics of the saturation area could comprise the location of the saturation area within the one or more images, and the one or more predefined matching criteria could then comprise establishing the match when the location of the saturation area and the location of the detection area indicate that the saturation area is included within the detection area. This embodiment is particularly advantageous for more difficult cases where the saturation and detection area may be further apart because it allows using the knowledge of the 3D geometry of a scene, which may be obtained from the acquired camera images as well.

In an embodiment, the match between the one or more characteristics of the detection area and the one or more characteristics of the saturation area may be established according to a maximum likelihood matching method, which advantageously provides a unified approach to making conclusions regarding the location of the first light source based on a statistical model.

In an embodiment, the step of identifying at least the portion of the saturation area as the location of the light source of the illumination system that provided the first light output comprising the identified first code could be based on using additional information, or metadata, indicative of one or more of a type of the first light source, a size of the first light source, and an expected mounting position of the first light source. The use of the metadata is expected to increase the chances of correct determination of the location of the image of the first light source.

In an embodiment, the step of providing the user interface illustrating the scene could comprise providing the user interface comprising at least one image, or a representation thereof, of the one or more images, the at least one image or the representation thereof comprising the image of the first light source being present within the scene. In this manner, a user is presented with a user interface that is intuitive for controlling the light sources present within the photographed scene.

In an embodiment, the first control icon could be provided in the user interface as an overlay at least partially overlapping with the image of the first light source or the light-effect of the first light source, clearly indicating to a user that the icon is to be used for controlling that particular light source.

In an embodiment, the first control icon could provide clickable interactive control whereby, in response to the user clicking on the first control icon within the user interface, a menu for controlling the first light source is provided to the user.

In an embodiment, the method may further comprise the steps of receiving, via the user interface, a user input indicating desire of the user to control the first light source, translating the received user input into one or more control commands for controlling the first light source, and providing the one or more control commands to the first light source. In this manner, the actual control of the light source is achieved.

In an embodiment, the one or more control commands may be provided to the first light source via a back channel. The advantage of this embodiment is that control of a light source can be carried out via this channel as soon as the identifier of the light source is detected using CL and the network address of that specific light source is derived from the identifier and used to control the light source. The back channel may be wired or wireless (radiofrequency, infrared or even CL).

In an embodiment at least one of the one or more acquired images was acquired by a rolling-shutter image sensor, where different portions of the image sensor are exposed at different points in time, so that the first sequence of modulations (i.e., the first code) is observable as alternating stripes in said at least one of the one or more acquired images. The use of rolling-shutter image sensors for the purpose of detecting CL is described in detail in patent application WO2012/127439A1, the disclosure of which is incorporated herein by reference in its entirety. One advantage of using a rolling-shutter image sensor is that such image sensors are simpler in design and, therefore, less costly (e.g. because less chip area is needed per pixel), than image sensors that use global shutter. Another advantage is that such image sensors are the sensors that are nowdays employed in tablets and smartphones, making these commonplace devices particularly suitable for implementing embodiments of the present invention.

According to an aspect of the present invention, a control system is disclosed. The control system comprises at least a processing unit configured for carrying out the methods described herein. In various embodiments, the processing unit may be implemented in hardware, in software, or as a hybrid solution having both hardware and software components. In an embodiment, the control system may further include a light detection means, e.g. a camera, for acquiring the one or more images to be processed by the processing unit. Such control systems may be implemented, for example, in a remote control for controlling the illumination system or included in another unit such as a tablet computer, a smartphone, a switch, or a sensor device which then may also be used for controlling the individual CL sources of the illumination system.

Moreover, a computer program for carrying out the methods described herein, as well as a non-transitory computer readable storage-medium storing the computer program are provided. A computer program may, for example, be downloaded (updated) to the existing control systems (e.g. to the existing optical receivers, remote controls, smartphones, or tablet computers) or be stored upon manufacturing of these systems.

Hereinafter, an embodiment of the invention will be described in further detail. It should be appreciated, however, that this embodiment may not be construed as limiting the scope of protection for the present invention.

### BRIEF DESCRIPTION OF THE DRAWINGS

FIG. 1 is a schematic illustration of an illumination system installed in a structure according to one embodiment of the present invention;

FIG. 2 is a schematic illustration of a control system, according to one embodiment of the present invention;

FIG. 3 is a flow diagram of method steps for enabling a user to control at least one CL source providing light contribution to a scene, according to one embodiment of the present invention;

FIG. 4 is a schematic illustration of one of the acquired images when two light sources provide light contributions to a scene, according to one embodiment of the present invention; and

FIG. 5 is a schematic illustration of a user interface providing control icons for controlling the light sources providing light contributions to the scene, according to one embodiment of the present invention;

FIG. 6 is a flow diagram of further method steps for enabling a user to control at least one CL source providing light contribution to a scene, according to one embodiment of the present invention; and

FIG. 7 is a schematic illustration of the detection and the saturation areas of a light source covered with a shade, according to one embodiment of the present invention.

### DETAILED DESCRIPTION

In the following description, numerous specific details are set forth to provide a more thorough understanding of the present invention. However, it will be apparent to one of skill in the art that the present invention may be practiced without one or more of these specific details. In other instances, well-known features have not been described in order to avoid obscuring the present invention.

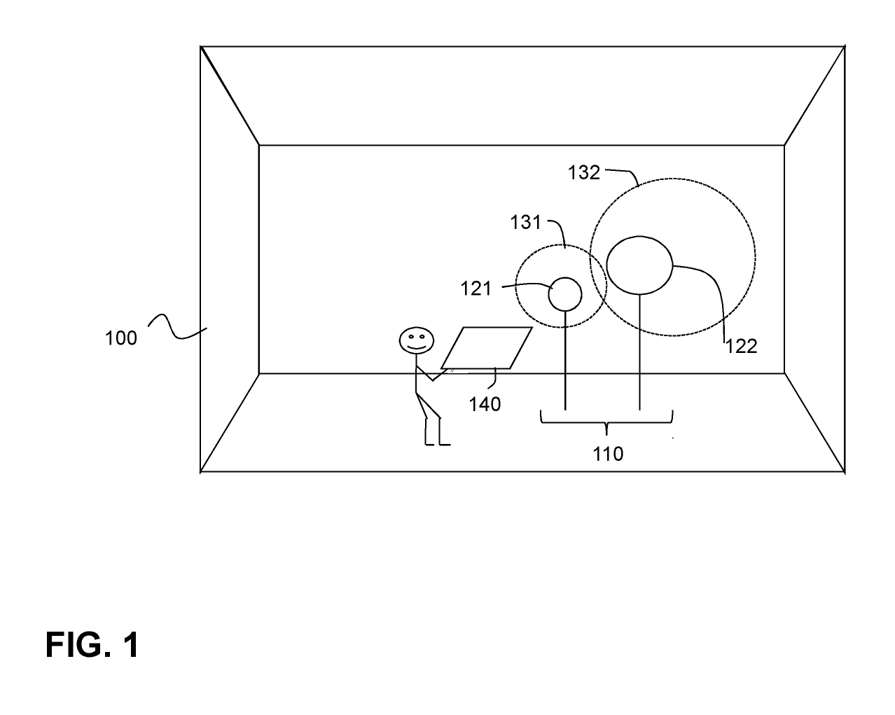

FIG. 1 illustrates an exemplary structure 100, here being a room, in which an illumination system 110 is installed. In the illustrative embodiment shown in FIG. 1, the illumination system 110 comprises two light sources 121 and 122. The light sources may comprise any suitable source of light such as e.g. high/low pressure gas discharge sources, laser diodes, inorganic/organic light emitting diodes, incandescent sources, or halogen sources. During operation, the light output provided by the light source 121 and/or the light output provided by the light source 122 contribute to the total illumination provided by the illumination system 110 for illuminating at least parts of the structure 100. The illumination contributions from the light sources 121 and 122 on the structure are shown in FIG. 1 as footprints 131 and 132, respectively. The footprints from the light sources may overlap.

The light output of at least one of the light sources 120, 120 is coded such that the light output comprises an individual identifier code ID#1, 2, respectively, which is typically an embedded code emitted as a temporal sequence of modulations in the characteristics of the light emitted from the light source. As used herein, the terms “identifier” or “ID code” refer to any codes that allow sufficient identification of individual CL sources within the illumination system. The coded light produced by a CL source may further comprise other information regarding the light source, such as e.g. current light settings and/or other information, but for sake of simplicity, only the identifier code is discussed herein to illustrate the basic idea of the inventive concept.

The codes are embedded into the light outputs of the CL sources by modulating a drive signal to be applied to a light source in response to a particular code signal. There are various techniques for embedding a code into the light output of a light source (e.g. pulse width modulation, amplitude modulation, etc.) which are known to people skilled in the art and, therefore, are not described here in detail.

In an embodiment, the identifier code may comprise a repeating sequence of N symbols (e.g. bits). As used herein, the term “symbol” applies not only to single bits, but also to multiple bits represented by a single symbol. Examples of the latter are multi-level symbols, where not only 0 and 1 exist to embed data, but multiple discrete levels. In this manner, the total light output of the illumination system may contain a plurality of identifier codes, each originating from the individual light source.

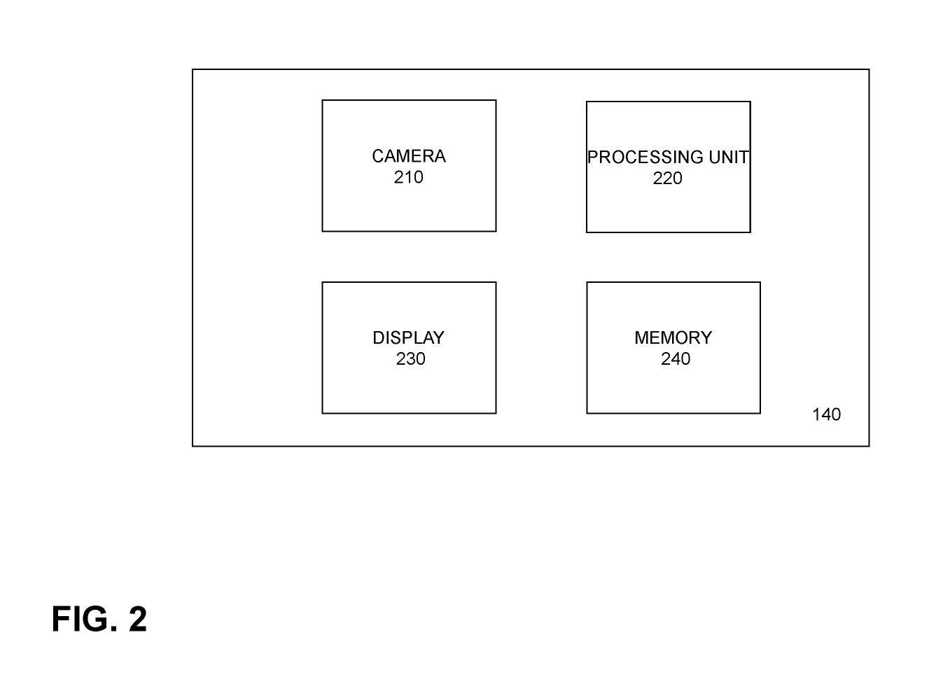

The illumination system 110 further comprises a control system 140 for allowing a user to control at least those of the light sources 120 and 121 that are configured to produce CL. For illustrative purposes, it is assumed that both of the light sources 120 and 121 are CL sources producing CL with different identifiers ID#1 and ID#2, respectively. FIG. 2 illustrates the control system 140 in greater detail, according to one embodiment of the present invention. However, the teachings described herein are also applicable to controlling CL sources within illumination systems comprising any number of multiple light sources of which one or more are CL sources. For example, the teachings described herein are applicable to illumination systems having only one CL source and one or more non-CL sources (e.g. the illumination system 110 where the light source 121 is a CL source and the light source 122 is not a CL source).

As shown in FIG. 2, the control system 140 includes light detection means 210 in a form of a camera configured for acquiring one or more images of a scene, a processing unit 220 configured for processing the acquired images according to the methods described herein, and a display 230 for displaying a user interface for controlling the CL sources of the illumination system. Optionally, the control system 140 also includes a memory 240 and a specifically designated control (RF/WiFi) unit (not shown in FIG. 2) for controlling the light sources. Further, while the control system 140 is illustrated as a single unit, persons skilled in the art will realize that functionality of the individual elements illustrated in FIG. 2 to be within the system 140 could also be distributed among several other units.

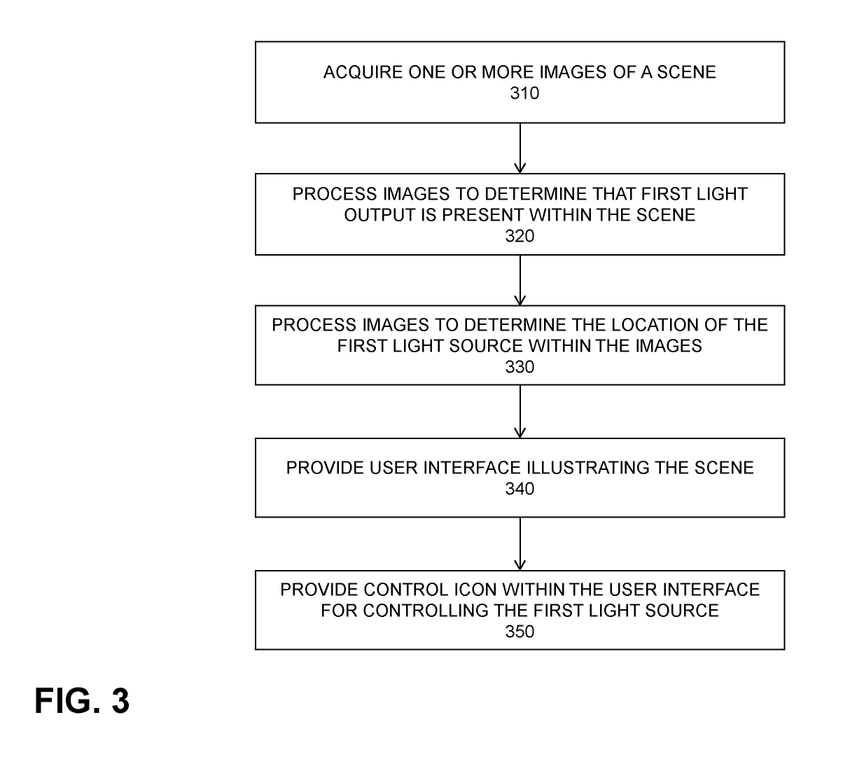

FIG. 3 is a flow diagram of method steps for enabling a user to control at least one CL source providing light contribution to a scene, according to one embodiment of the present invention. Since, as described above, it is assumed that both of the light sources 120 and 121 produce CL, following the method steps of FIG. 3 enables a user to control both of these light sources. While the method steps are described in conjunction with the elements shown in FIGS. 1 and 2, persons skilled in the art will recognize that any system configured to perform the method steps, in any order, is within the scope of the present invention.

The method of FIG. 3 may begin with a step 310, where the camera 210 acquires one or more images of a scene. The scene is selected to be such that at least a part of the scene includes at least a part of light output of a CL source to be controlled and that at least a part of the scene includes the CL source itself. This means, that, if e.g. of the light sources 121 and 122 only light source 121 was a CL source, then the scene should be selected such as to include at least a part of the footprint 131 as well as the light source 121 itself. In the present example where both light sources 121 and 122 are CL sources, this means that the scene is selected such as to include at least parts of the footprints 131, 132 as well as the light sources 121, 122.

One purpose of acquiring the one or more images is to later detect whether a light output of a particular CL source is present within the scene. Thus, the minimum number of images acquired should be such that the acquired images allow such detection. Because various detection techniques are well-known, a person skilled in the art will recognize how many images are sufficient for carrying out the detection in a given setting. The minimum number of images depends e.g. on one or more of the types and the number of the light sources, the technique used for embedding the code into the light output of the light sources, the camera used, and the detection technique employed in processing the images. For example, if a rolling shutter camera is used, where different portions of the image sensor(s) of the camera are exposed at different points in time, only a single image is sufficient as the embedded code may be observable as alternating stripes in the image, as e.g. described in U.S. Pat. No. 8,248,467 B1, WO2012/127439A1, and U.S. 61/698,761. One the other hand, if a global shutter camera is used, where all portions of the image sensor(s) of the camera are exposed at the same time instances during a frame, and embedded codes comprise repeating sequences of N symbols, then, as described in WO2011/086501A1, at least N different images should be acquired, each image is acquired with a total exposure time comprising one or more exposure instances at different temporal positions within the repeating sequence of N symbols. Of course, more images may be acquired in order to e.g. improve the probability of detection of the light output of various light sources or to track changes in the light contributions of the different light sources over time.

After the one or more images have been acquired, the method proceeds to step 320, where the processing unit 220 can process at least some of the acquired images to determine that the light output of the light source 121 is present within the scene using any of the known detection techniques. To that end, the processing unit 220 may be configured to identify, from the acquired images, the ID code that was embedded in the light output of the light source 121. In one embodiment, the processing unit 220 may have access to the ID codes of various CL sources within the illumination system 110 or derivates of those ID codes, i.e. parameters from which information regarding the ID codes may be obtained. In another embodiment, the ID codes of at least some of the CL sources within the illumination system may not initially be known to the processing unit 220. If this is the case, then the processing unit 220 may only have access to the protocol that is used to encode the messages in the coded light. In case the used protocol is not known in advance, the processing unit 220 may be arranged to be capable of recognizing the used protocol, in order to be able to decode the message in the encoded light. Thus, identifying the ID code embedded in the light output of the light source 121 could comprise either the determination that the ID code to which the processing unit 220 has access to before step 320 is present in the acquired images, or determination of the ID code from the acquired images where the ID code was not previously known to the processing unit 220. The processing unit 220 can similarly process the acquired images to determine whether the light output of the light source 122 is present within the scene.

In step 330, which could take place before or simultaneously with the step 320, the processing unit 220 also processed at least some of the acquired images to determine the location of the image of at least one CL source within the acquired images. In the present example where two light sources of the illumination system are CL sources, the processing unit 220 determines both the location of the image of the light source 121 and that of the light source 122. In one embodiment, this may be done using the centroids of the detection and saturation area. In another embodiment, this may be done using the locations of the saturated area (i.e., the light source itself) and the detection area (e.g., footprint of that light source on a wall). If the 3D geometrical model of a room is estimated from the images, e.g. by perspective information, then the estimated 3D model can be used to estimate the positions of the light sources in a 3D space and relate them back to the positions of the images of these light sources in the acquired images.

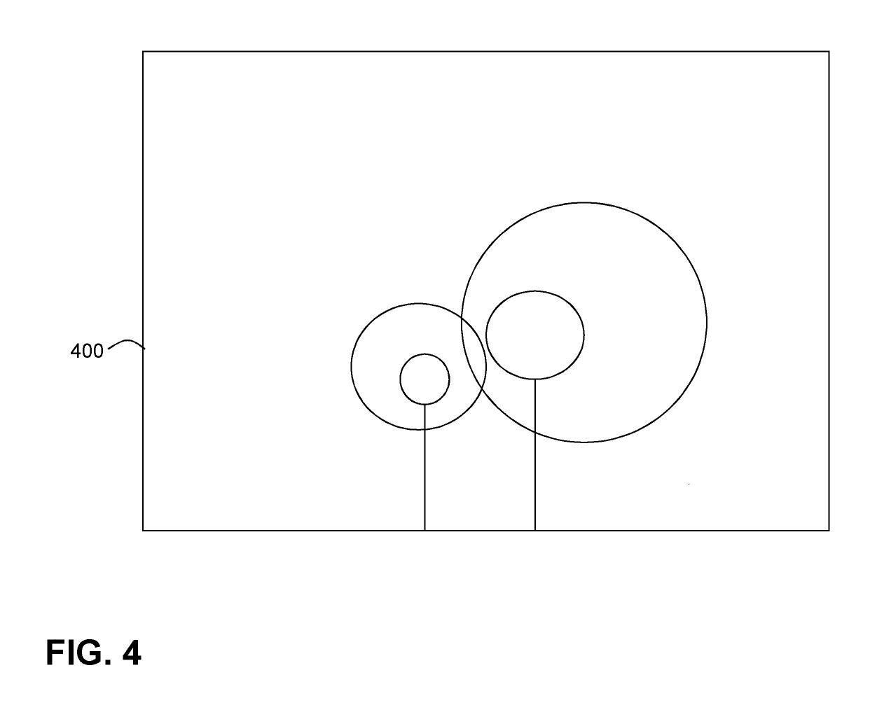

In step 340, the processing unit 220 is configured to generate a user interface illustrating the scene for which the images where acquired. Such a user interface may e.g. comprise one of the acquired images, or a schematic representation (i.e., a simplified drawing) illustrating the scene. Since the scene was selected such as to include the CL sources to be controlled, the user interface will include images of these CL sources within the scene, as e.g. shown with a user interface 400 in FIG. 4.

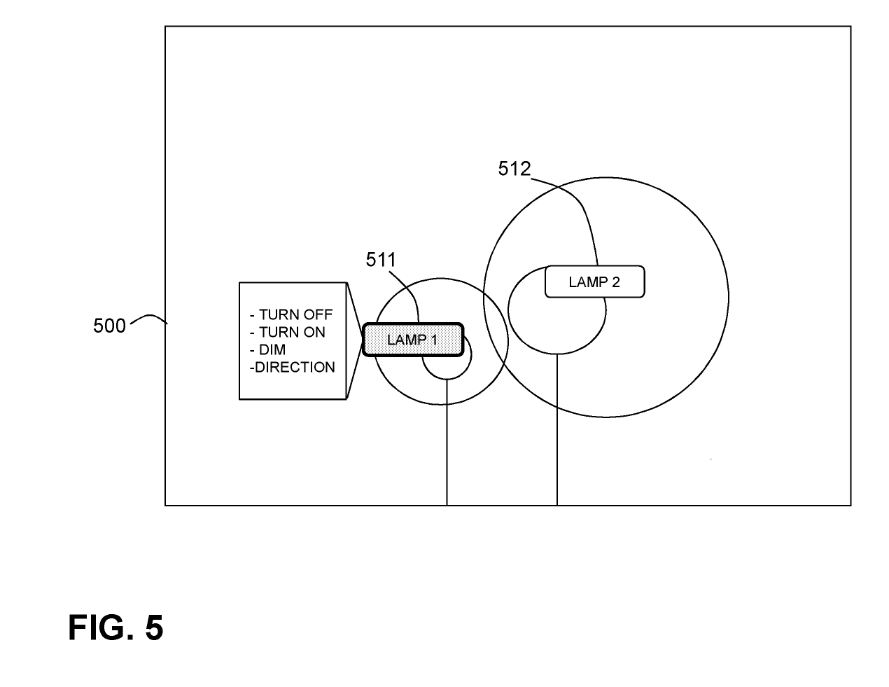

The method ends in step 350, where the processing unit 220 provides control icons within the user interface for controlling those CL sources of the illumination system that contributed to the total light output within the scene, as determined in step 320, and whose location was determined in step 330, i.e. the light sources 121 and/or 122 in this example. The control icons are placed within the user interface in such a manner, with respect to the location of the images of the light sources determined in step 330, as to illustrate to a user that the icons are to be used for controlling the respective CL sources. For example, this may be achieved as shown in FIG. 5, illustrating a user interface 500 comprising a control icon 511 for the light source 121 and a control icon 512 for the light source 122. Because the control icons 511 and 512 are placed in the user interface as visual overlays at least partially overlapping with the images of the light sources 121 and 122, respectively, it is intuitive to a user that these icons are to be used for controlling the respective light sources. Additionally or alternatively, this may also be achieved by indicating the contour of the area, within the user interface showing one of the acquired images, where the ID code of a certain CL source is present.

In an embodiment, the control icons may provide clickable interactive control whereby, in response to the user clicking on the control icon within the user interface, a menu for controlling the first light source is provided to the user. This is illustrated in FIG. 5, where the icon 511 has a different shading than the icon 512 indicating that the icon 511 has been selected (e.g., clicked on) by the user, where, in response to the selection of the user, a menu 521 is displayed indicating various options for controlling the light source 121. As shown in the exemplary illustrative embodiment of FIG. 5, in this case, the user may select to turn off, turn on, dim, or change the direction of illumination of the light source 121. Thus, in an optional embodiment, the method could include an additional step after step 350, where the processing unit 220 may receive, via the user interface, a user input indicating desire of the user to control the light source 121 and translate the received user input into one or more control commands for controlling the light source 121. The control commands may then be provided to the light source 121, e.g. via a radiofrequency back channel.

In an embodiment, the CL sources within the illumination system 110 could be connected to a local IP network by Ethernet cables, and the control system 140, such as e.g. an iPad, could communicate with the CL sources via a WiFi router connected to the same network. To that end, the control system 140 could use conventional WiFi discovery techniques to obtain the IP addresses of the CL sources, and then match the IP addresses to the IDs obtained from the coded light detected e.g. as a part of step 320.

The foregoing method is applicable for enabling a user to control those CL sources within an illumination system that actually provide light contribution to a scene at the moment that the one or more images of the scene are acquired. Therefore, in an embodiment, in order to provide the user with control icons for all CL sources present within the illumination system, the methods described herein may include the processing unit 220 providing a command to all of the CL sources within the illumination system 110 to turn on the CL sources so that each CL source provides sufficient light contribution to the scene during the short time when the one or more images are acquired in step 310.

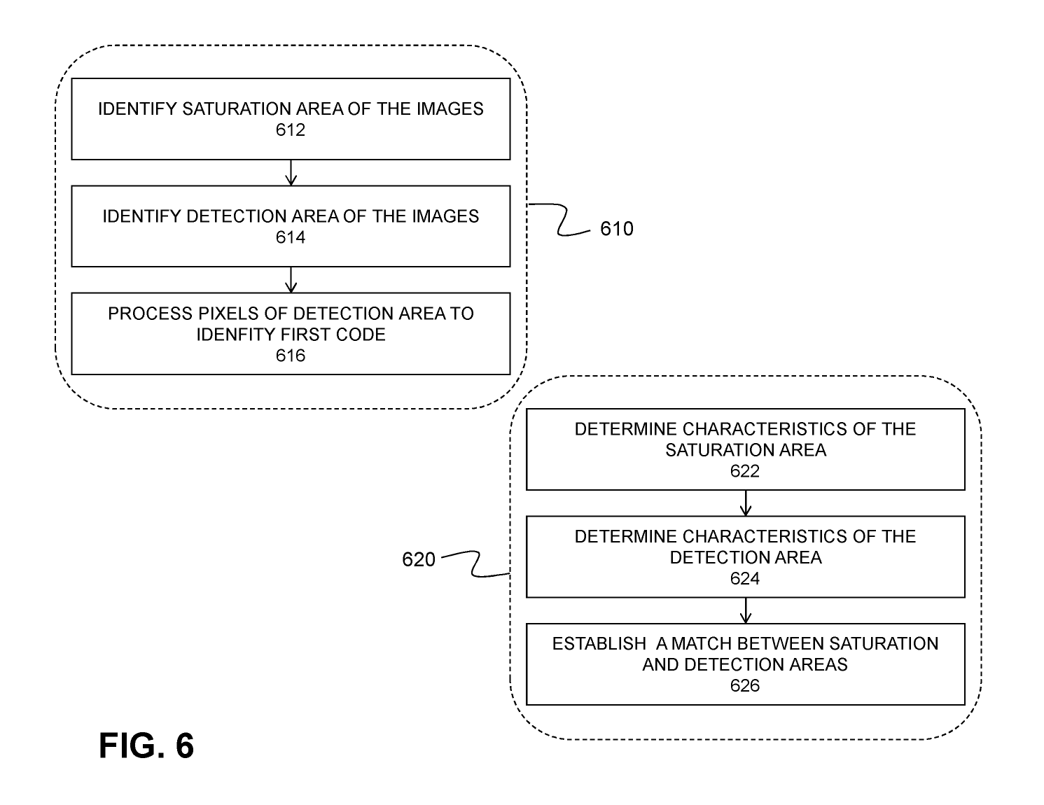

FIG. 6 is a flow diagram of further method steps for enabling a user to control at least one CL source providing light contribution to a scene, according to one embodiment of the present invention. Similar to the method steps of FIG. 3, while the method steps of FIG. 6 are described in conjunction with the elements shown in FIGS. 1 and 2, persons skilled in the art will recognize that any system configured to perform the method steps, in any order, is within the scope of the present invention.

The further steps of FIG. 6 deal with the situation where one or more of the CL sources providing light contribution to a scene are such that they saturate camera sensors when images are acquired in step 310 of FIG. 3. As previously described herein, when camera sensors are saturated, it may become impossible to detect the differences in the received signals and, therefore, impossible to detect embedded ID codes.

FIG. 6 is separated into a set of steps 610 and a set of steps 620. The set 610 is performed after step 310 and either before or as a part of step 320 of FIG. 3. The set 620 is performed after step 310 of FIG. 3 and after steps 612 and 614 of FIG. 6, and either before or as a part of step 330 of FIG. 3.

When, in step 310, an image is taken, the camera 210 acquires intensities of the total light output of the illumination system at all of the positions within a scene. In the present application, whenever the term “intensity” (of the light output) is used, it is understood that a “derivative of the intensity” is included as well, such as e.g. the light color, color temperature, light spectrum, and change in light intensity. The image is commonly divided into a plurality of pixels, where each pixel represents an intensity of the total light output of the illumination system at a different physical position within the scene. In the current example illustrated in FIGS. 4 and 5, the total light output of the illumination system comprises the light contribution from the light source 121 and the light contribution from the light source 121.

In step 612, the processing unit 220 identifies one or more saturation areas of the images, where a saturation area comprises one or more pixels comprising an intensity above a predetermined threshold, indicating saturation of the camera sensor providing that pixel data. In step 614, the processing unit 220 identifies one or more detection areas of the images, where a detection area comprises a plurality of pixels allowing identification of the embedded codes present within the scene. This may be done by e.g. dividing the images into small segments and determining, per segment, the presence of a CL identifier.

In step 616, the processing unit 220 can determine that the light output of the light source 121 is present within the scene by processing one or more pixels of the identified detection area(s) to identify the code ID#1 that was embedded into the light output of the light source 121. Similarly, the processing unit 220 can determine that the light output of the light source 122 is present within the scene by processing one or more pixels of the identified detection area(s) to identify the code ID#2 embedded into the light output of the light source 122.

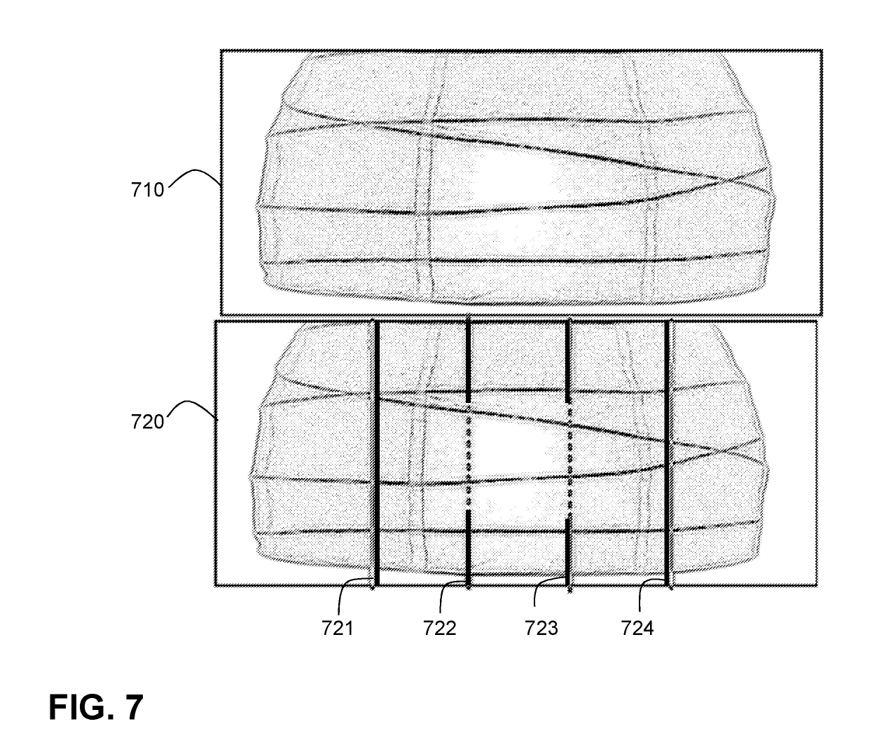

Steps 612-616 are based on an experimental observation that, even though it is not possible to detect embedded codes from the pixels of the images that are saturated, it is usually possible to identify areas neighboring the saturating spot(s) which are illuminated by the same bright light source but are not saturating the camera sensors, a so-called “halo” effect. One typical case would be the one of a light source placed relatively close to a wall, e.g. in front of a wall, where, while the light source itself may be too bright to allow detection of CL light from it, the reflection of the light emitted by that light source from the wall may allow detection of the CL. Another typical case would be the one of a light source such as e.g. a light bulb with a lamp shade around it. The lamp shade diffuses the light from the light bulb, so while the bulb itself would still saturate the camera's sensors, the surrounding part of the lamp shade would not. This case is illustrated in FIG. 7, where 710 represents one of the acquired images and 720 represents the same image with overlaid vertical lines 721-724. The solid parts of the lines 721-724 indicate portions of the image where detection of CL is possible (i.e., portions of the detection area(s)), while the dashed pats of the lines 721-724 indicate portions of the image where detection of CL is not possible (i.e., portions of the saturation area(s)). Thus, the identification of the saturation and detection areas in steps 612 and 614 could be done e.g. by identifying these areas from an image, as shown in 720. Alternatively, when the images are acquired using a rolling shutter image sensor, these areas could be identified from a sub-sampled version of the image, e.g. from a marginalized image. When the images for capturing the CL signal are acquired with a rolling shutter image sensor, the temporal identifier is transferred to a spatial signal in vertical direction. The signal can be summed in the direction of the line (i.e., the horizontal direction) to gain signal-to-noise ratio, and decrease the image size in order to save processing power. This summation into one direction is called marginalized summation, which allows identification of the saturation and detection areas from a marginalized image.

The “halo” effect can then be used to solve the problem of saturated camera sensors in that embedded codes may be detected from the “halo” (i.e., the one or more detection areas), as illustrated in the set 610 of FIG. 6, and thereafter the light sources contributing to the halo can be identified and associated with their respective ID codes detected from the halo, as illustrated in the set 620 of FIG. 6.

Proceeding with the set 620, in step 622 the processing unit 220 determines one or more characteristics of the saturation area(s) identified in step 612 and in step 624 the processing unit 220 determines one or more characteristics of the detection area(s) identified in step 614. For each one of the saturation and the detection areas, the one or more characteristics could include e.g. the centroid of the area, the location of the area within the acquired images, the size of the area, the contour of the area, and the color of the area.

In step 626, the processing unit 220 establishes whether there is a match between each identified saturation area and each identified detection area according to one or more predefined criteria for establishing the match. In an embodiment, the match may comprise a maximum likelihood estimation based on matching the characteristics of a particular detection area with the characteristics of a particular saturation area of the acquired images. The predefined matching criteria could include minimal distance between the centroid of the detection area and the centroid of the saturation area and/or at least partial inclusion of the saturation area within the detection area. When the processing unit 220 establishes that there is a match between a particular saturation area and a particular detection area, then it is possible to identify the light source causing the saturation in that saturation area as the light source that produced the embedded code detected in that detection area. Consequently, the location of the light source within the acquired images may be established as the location of one of the identified saturation areas (step 330 of FIG. 3) and a control icon could be placed in the correct location within the user interface as to indicate to a user that the icon is to be used to control that particular light source (step 350 of FIG. 3).

In a further embodiment of the invention, the processing unit 220 may use additional information in establishing a match between the saturation and the detection areas. For example, the CL sources themselves may be configured to provide additional data to the control system 140 by embedding that data into the light output in addition to their ID codes. The additional data could be related to e.g. the type of light produced by the light source (e.g. color, tunable white, etc.), the size of the light source, its typical mounting position, etc. Once this information is available to the processing unit 220, the maximum likelihood based matching performed in step 626 may be extended to incorporate these additional clues. For example, if the additional information indicates that the light source for which ID code was identified from the detection area is a spot luminaire mounted at the ceiling of a structure, then matching of that detection area to a saturation area in a form of a small circular clipped region in the top portion of the acquired image(s) is more likely than matching it to a saturation area in a form of a larger clipped area with an elongated shape because the latter is a more likely saturation area shape for a tube LED. In another example, the additional data could provide indication of the type of light that can be produced by the light sources present in the lighting system. The ratios of the detected identifier in the red, green and blue (RGB) channels of the image sensor can be compared with the RGB ratios of the individual light sources to yield a match with a particular light source or at least decrease the number of possible candidates.

Various embodiments of the invention may be implemented as a program product for use with a computer system, where the program(s) of the program product define functions of the embodiments (including the methods described herein). In one embodiment, the program(s) can be contained on a variety of non-transitory computer-readable storage media, where, as used herein, the expression “non-transitory computer readable storage media” comprises all computer-readable media, with the sole exception being a transitory, propagating signal. In another embodiment, the program(s) can be contained on a variety of transitory computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., flash memory, floppy disks within a diskette drive or hard-disk drive or any type of solid-state random-access semiconductor memory) on which alterable information is stored. The computer program may be run on the processing unit 220 described herein.

While the forgoing is directed to embodiments of the present invention, other and further embodiments of the invention may be devised without departing from the basic scope thereof. For example, aspects of the present invention may be implemented in hardware or software or in a combination of hardware and software. Therefore, the scope of the present invention is determined by the claims that follow.

1. A method comprising, after obtaining one or more images of a scene being illuminated by an illumination system that comprises at least a first light source, each image comprising a matrix of pixels, the first light source being present within the scene and being configured for providing a first light output comprising a first code, the first code being embedded into the first light output as a first sequence of modulations in one or more characteristics thereof, steps of:
identifying a saturation area of the one or more images, the saturation area comprising, for each of the one or more images, one or more pixels comprising an intensity above a predetermined threshold,
identifying a detection area of the one or more images, the detection area comprising, a plurality of pixels allowing identification of the first code,
processing the one or more images to determine, based on the first code embedded into the first light output, that the first light output is present within the scene, the determination that the first light output is present comprising processing the plurality of pixels of the detection area to identify the first code,
determining one or more characteristics of the detection area,
determining one or more characteristics of the saturation area,
processing the one or more images to determine the location of the first light source within the one or more images, the determination of the location of the first light source comprises identifying at least a portion of the saturation area as the location of the light source of the illumination system that provided the first light output comprising the identified first code when a match according to one or more predefined matching criteria is established between the determined one or more characteristics of the detection area and the determined one or more characteristics of the saturation area,
providing a user interface illustrating the scene,
providing a first control icon within the user interface, the first control icon indicating to a user, based on the determined location of the first light source, that the first control icon is adapted to control the first light source.

2. (canceled)

3. The method according to claim 1, wherein the one or more characteristics of the detection area comprises the centroid of the detection area, the one or more characteristics of the saturation area comprises the centroid of the saturation area, and the one or more predefined matching criteria comprises establishing the match when a distance between the centroid of the detection area and the centroid of the saturation area is less than a predefined threshold distance.

4. The method according to claim 1, wherein the one or more characteristics of the detection area comprises the location of the detection area within the one or more images, the one or more characteristics of the saturation area comprises the location of the saturation area within the one or more images, and the one or more predefined matching criteria comprises establishing the match when the location of the saturation area and the location of the detection area indicate that the saturation area is included within the detection area.

5. The method according to claim 1, wherein the match between the one or more characteristics of the detection area and the one or more characteristics of the saturation area is established according to a maximum likelihood matching method.

6. The method according to claim 1, wherein the step of identifying at least the portion of the saturation area as the location of the light source of the illumination system that provided the first light output comprising the identified first code is based on using additional information indicative of one or more of a type of the first light source, a size of the first light source, and an expected mounting position of the first light source.

7. The method according to claim 1, wherein the step of providing the user interface illustrating the scene comprises providing the user interface comprising at least one image, or a representation thereof, of the one or more images, the at least one image or the representation thereof comprising the first light source, or a representation thereof, being present within the scene.

8. The method according to claim 7, wherein the first control icon is provided as an overlay at least partially overlapping with the first light source or the representation thereof.

9. The method according to claim 1, wherein the first control icon provides clickable interactive control whereby, in response to the user clicking on the first control icon within the user interface, a menu for controlling the first light source is provided to the user.

10. The method according to claim 1, further comprising receiving, via the user interface, a user input indicating desire of the user to control the first light source, translating the received user input into one or more control commands for controlling the first light source, and providing the one or more control commands to the first light source.

11. A computer program product comprising software code portions configured for, when executed on a processing unit, performing the steps of the method according to claim 1.

12. A system comprising at least a processing unit configured for performing the steps of the method according to claim 1.

13. The system according to claim 12, further comprising light detection means configured for acquiring the one or more images of the scene.

14. The system according to claim 12, further comprising display means configured for displaying the user interface.
